(19) United States
(12) Patent Application Publication
(10) Pub. No.: US 2010/0273074 A1
(43) Pub. Date: Oct. 28, 2010

(54) Fuel cell system and method for operating a fuel cell system

(75) Inventors: Arno Mattejat, Erlangen (DE); Walter Stühler, Hirschaid (DE)

Correspondence Address: SIEMENS CORPORATION;INTELLECTUAL PROPERTY DEPARTMENT, 170 WOOD AVENUE SOUTH, ISELIN, NJ, 08830, US

(73) Assignee: SIEMENS AKTIENGESELLSCHAFT, München (DE)

(21) Appl. No.: 12/308,500

(22) PCT Filed: Jun. 15, 2007
(86) PCT No.: PCT/EP2007/055947

§ 371 Date: Dec. 16, 2008

(30) Foreign Application Priority Data
Jul. 3, 2006 (DE) 10 2006 030 612.0

(51) Int. Cl. H01M 8/04

(52) U.S. Cl. 429/432

(57) ABSTRACT

Disclosed is a fuel cell system comprising a fuel cell stack, supplied with a reaction gas on the gas inlet side and comprises at least one flush valve on the gas outlet side on a flush cell. A control device, which controls the actuation of the flush valve as a function of the voltage of the flush cell, is provided, wherein the voltage tap is provided in a region of the flush cell at which the concentration of the reaction gas drops the fastest to a predefined threshold value. Due to the voltage tap in the region where the concentration of the reaction gases drop the fastest to a predefined threshold value, a significantly more sensitive and precise regulation of the flush is possible and voltage dips are effectively prevented in the flush cell, as a result of which the overall risk of corrosion are minimized for the flush cell.

The invention relates to a fuel cell system according to the preamble of claim 1 and a method for operating a fuel cell system according to the preamble of claim 5; a fuel cell system of this type and/or a method of this type are known for instance from WO 2006/003158 A1.

During operation of a fuel cell system, a fuel gas on the anode side, for instance hydrogen, and air or oxygen on the cathode side is conventionally supplied as an additional reaction gas to a fuel cell block formed from stacked fuel cells in order to generate electrical current. A plurality of different types of fuel cell systems now exist, which differ in terms of their design and in particular in terms of the electrolytes used as well as in terms of the necessary operating temperature. With a so-called PEM fuel cell (proton exchange membrane), a polymer membrane is arranged between a gas-permeable anode and a gas-permeable cathode, said polymer membrane being permeable to hydrogen protons. As a single fuel cell supplies a voltage of only approximately 0.7 to 0.9 volts, several fuel cells are electrically connected in series with one another to form a stack. The individual fuel cells are usually separated here from one another by means of a bipolar plate. In this way, the bipolar plate generally has a type of grooved or ridged structure and rests against the anode and/or the cathode. The grooved or ridged structure forms a gas compartment between the bipolar plate and the anode and/or cathode, through which the reaction gases flow.

During operation of a PEM fuel cell, hydrogen protons travel through the electrolytes on the oxygen side and react with the oxygen. Reaction water accumulates here as a reaction product. The conventional wetting of the reaction gases prior to their entry into the fuel cell also introduces water into the gas compartments. In addition to the water, inert gases also accumulate, depending on the percentage purity of the reaction gases used. In the case of a fuel cell system with several fuel cell stacks arranged consecutively in series in a cascade-like manner, the water and the inert gases accumulate in the last stack or the last fuel cell. The reaction gases are thus enriched there with inert gas. This “reactant thinning”, results in a voltage drop in the last fuel cell and/or the last fuel cell stack.

This fuel cell stack is thus flushed at certain time intervals, i.e. a flush line connected to the stack on the gas outlet side is opened by way of a flush valve so that the accumulated water and the inert gases are discharged. The last fuel cell or the last fuel cell stack are thus also referred to as flush cells and/or as a flush cell stack. The voltage drop is usually used as a control signal for opening the flush valve. The flush process allows the concentration of the inert gases to be enriched so that the voltage level is increased again.

In the event of an enrichment with inert gases, the flush cells are still only insufficiently supplied with the reaction gases in the case of a simultaneously flowing current. The boundary conditions for water electrolysis are thus present and the partial reaction 4OH—>O₂+2H₂O+2e results on the anode side. Oxygen is thus formed, which can result in corrosion on the flush cells. This problem exists in particular if the voltage in the flush cells drops to the range of the corrosion potential of the used material.

WO 2006/003158 A1 discloses avoiding this corrosion risk such that the voltage tap for measuring the voltage in the flush cell is located in the region of the gas outlet to the flush valve. The term “in the region of the gas outlet” is understood here to mean the arrangement of the voltage tap approximately at the level of the gas outlet.

The object underlying the invention is to enable an even more reliable operation of a fuel cell system with even less risk of corrosion.

The object is achieved according to the invention by a fuel cell system with the features of claim 1.

The invention assumes the idea that the region of the fuel cell, which is exposed to the greatest risk of corrosion, is that in which impermissibly low concentrations of reaction gas occur most quickly. As it transpires, this region does not necessarily have to be located in the region of the gas outlet, but it may instead, as a function of the design of the gas compartment, also be located at other points in the gas compartment. In the case of a gas compartment with a largely homogenous flow resistance, as is present with grooved structures, this region may be located where reaction gases have covered a long flow passage, without mixing with other gas flows. The region is in particular in “dead corners” of the gas compartment, in which, by comparison with the gas outlet region, significantly lower flows materialize.

The precise region in which the concentration of the reaction gas falls most quickly to a predefined threshold value can be determined here in a computational or also experimental fashion.

A voltage tap in the region in which the concentration of the reaction gas falls most quickly to a predefined threshold value ensures that at no point in the gas compartment is the level below the corrosion potential, as a result of which the risk of corrosion can be significantly reduced. It has also transpired that a voltage tap of this type enables a particularly precise and sensitive control or regulation of the actuation of the flush valve, as a result of which control or regulation-specific improvements result overall. By comparison with a voltage tap in the region of the gas outlet, this naturally results in increased flush processes, i.e. the flush rate is increased.

If a bipolar plate is arranged between two fuel cells, the voltage tap is preferably provided in the region of an edge side of the bipolar plate.

For as efficient a utilization of the reaction gases as possible, the fuel cell system has several fuel cell stacks arranged in a cascade-like manner. A sequence of fuel cell stacks is understood here, which are passed through in series by reaction gases, with the number of fuel cells of the individual consecutive stacks successively reducing in the flow direction of the reaction gases. The drop in the number of fuel cells is matched here to the respective residual gas quantity, which escapes from the preceding fuel cell stack. The last fuel cell stack is embodied as a flush cell stack with one or several flush cells, to which the flush valve connects.

The invention can likewise also be applied to a fuel cell system with a single fuel cell block which is passed through in parallel by reaction gases.

The fuel cell system is preferably embodied with PEM fuel cells.

The object is achieved in accordance with the invention by a method having the features of claim 5. The advantages cited in respect of the fuel cell system and preferred embodiments can in turn also be transferred to the method.

Exemplary embodiments of the invention are described in more detail below with reference to the drawing, in which are shown schematic and significantly simplified representations of

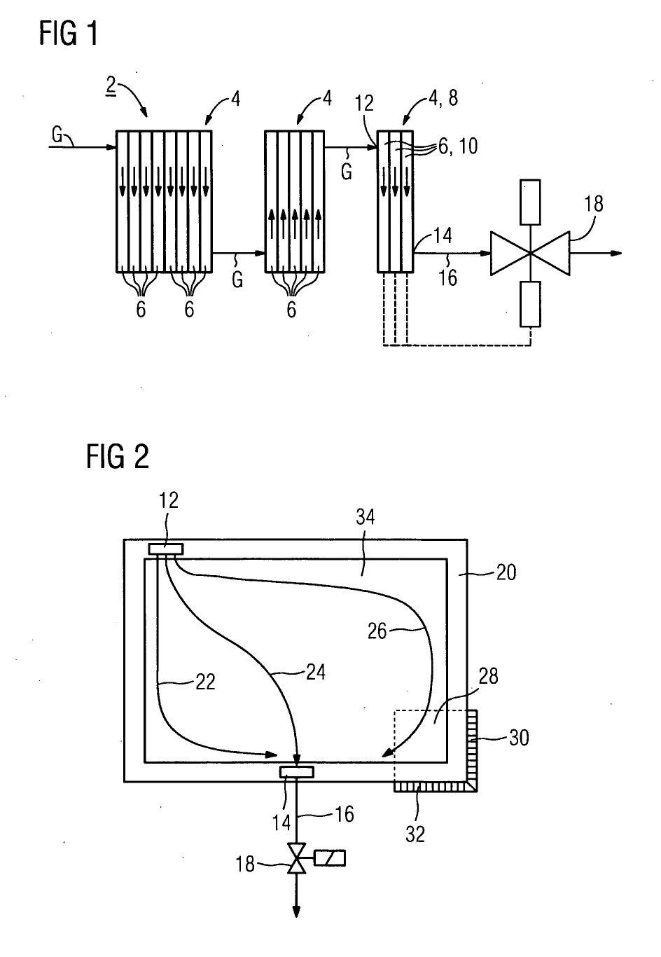

FIG. 1 a design of a fuel cell system with fuel cell stacks arranged in a cascade-like manner

FIG. 2 a voltage tap in the case of a first bipolar plate

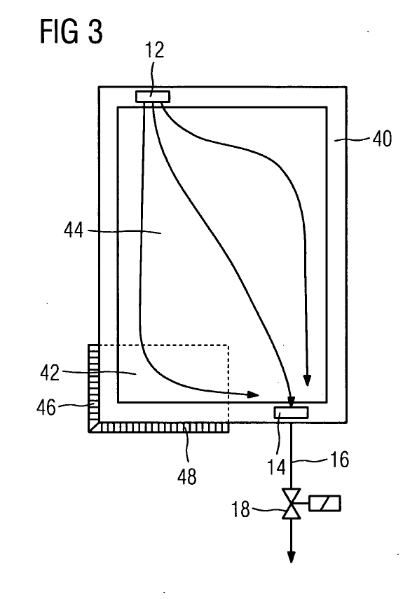

FIG. 3 a voltage tap in the case of a second bipolar plate

According to FIG. 1, a fuel cell system 2 has several fuel cell stacks 4 arranged in a cascade-like fashion in respect of each other, which, in turn, each consist of several fuel cells 6. The individual fuel cell stacks 4 are arranged here in series with one another on the gas side. A reaction gas G in an upper region is fed to the first fuel cell stack on the gas side and flows through the individual fuel cells 6 in parallel in the direction of the downward pointing arrow. The reaction gas G leaves the first fuel cell stack 4 there and is routed into the next fuel cell stack 4.

The last fuel cell stack is embodied as a fuel cell stack 8 with several flush cells 10. The reaction gas G in the region of a gas outlet 12 is fed to the flush cell stack 8 and flows through the individual flush cells 10 downwards in the direction of a gas outlet 14. A flush line 16 connects to the gas outlet 14, said flush line 16 being connectable by way of a controllable flush valve 18.

The individual flush cells 10 are separated from one another in each instance by a bipolar plate 20, which is shown schematically in FIG. 2, and which have the upper gas outlet 12 and the lower gas outlet 14. The terms “lower” and “upper” refer here to the flow direction of the reaction gas G. The direction of the electrical current which flows during operation is oriented vertically to the bipolar plate 20 and/or to the tracing surface.

During operation of the fuel cell system, the flush valve 18 is firstly closed so that reaction water and inert gases which develop in the flush cells 10 during the reaction and which are present in the reaction gases become enriched. Through enrichment of the inert gases, the flush cell voltage drops. This is measured and used to control or regulate a flush process, in other words to control or regulate the flush valve 18. If the voltage does not reach a predefined control value, the flush valve 18 opens and the reaction water and the residual gas located in the flush cells 10, in particular the inert gases, are discharged. Expediently, both the oxygen or cathode side as well as the hydrogen, or anode side of the flush cells 10, are preferably flushed here by way of a flush valve 18 in each instance, in particular at the same time.

As a result of the enrichment with inert gases, the flush cells are still only inadequately supplied with the reaction gases with a simultaneously flowing current. The boundary conditions for water electrolysis are thus present and a partial reaction 4OH—>O₂+2H₂O+2e results on the anode side. Oxygen is thus formed, which can result in corrosion in the case of the conventionally metallic bipolar plate 20. This problem then exists in particular if the voltage in the flush cells 10 drops to the range of the corrosion potential of the material used for the bipolar plates 20.

With the bipolar plate shown in FIG. 2, a ridged or grooved structure (not shown in further detail) ensures that the gas is delivered from the gas inlet to the gas outlet across the whole surface of the gas compartment, i.e. the reaction gases are distributed in the region of the gas inlet 12 across the whole surface of the gas compartment 34 and are combined again in the region of the gas outlet 14. Different lengths of gas passages 22, 24, 26 result in the gas compartment 34 however. Reaction gases which flow along the gas passage 26 have to cover the longest route from the gas inlet 12 to the gas outlet 14. In the right lower edge region 28 of the gas compartment 34, the comparatively most minimal gas movements of the whole gas compartment 32 will thus materialize, since on the one hand the gas flow is interrupted by the geometric design of the gas compartment 34 and on the other hand the reaction gases also have traversed the greatest distance without mixing with other reaction gases. As a result, the reaction gas concentration falls most quickly to a predefined threshold value in the corner region 28.

By comparison, the gas delivered by way of the gas passage 26 in the region of the gas outlet 14 has however covered an even greater distance, but is however already mixed there again with gas, which was conveyed by way of the gas passage 24 and thus has a higher reaction gas concentration. In the region of the gas outlet 14, the reaction gas concentration thus falls more slowly to the predefined threshold value than in the corner region 28.

The voltage tap for the control or regulation of the flush process is thus provided on the bipolar plate 20 in the corner region 28 of the gas compartment, preferably in the region on the right lateral edge side 30 or the lower edge side 32 of the bipolar plate 20.

FIG. 3 shows a bipolar plate 40 of a rectangular fuel cell with a diagonal gas delivery channel. The region, in which the reaction gas concentration falls most quickly to a predefined threshold value, is located in the left lower corner region 42 of the gas compartment 44, since the most minimal gas movements are adjusted there. The voltage tap for regulating the flush is thus preferably provided in the left lower corner region 42 of the bipolar plate 40, in particular in the region on the left edge side 46 or on the lower edge side 48 of the bipolar plate 40.

The region or regions in which the reaction gas concentration(s) fall(s) most quickly to a predefined threshold value can basically be determined in a computational or experimental fashion. The threshold value is preferably selected such that it lies above the corrosion potential of the bipolar plates 20, 40.

If several flush cells are supplied with reaction gas in parallel, the control or regulation can likewise depend on the fastest fall in the cell voltage as a result of the fastest fall in the reaction gas concentrations. In this case, regulation need only be built up such that the cell with the quickest fall triggers the flushing process.

1.-6. (canceled)

7. A fuel cell system, comprising:
a fuel cell stack having
a gas inlet side configured to admit a reaction gas,
at least one flush valve arranged on a gas outlet side of a flush cell, and
a voltage tap arranged in a region of the flush cell where a concentration of the reaction gas falls most quickly to a predefined threshold value; and
a control configured to control an actuation of the flush valve as a function of the voltage of the flush cell.

8. The fuel cell system as claimed in claim 7, wherein a bipolar plate is arranged between two fuel cells of the fuel cell stack and the voltage tap is arranged in a region of an edge side of the bipolar plate.

9. The fuel cell system claimed in claim 8, wherein the system is configured for a plurality of fuel cell stacks arranged in a cascade-like manner.

10. The fuel cell system as claimed in claim 9, wherein the fuel cells are PEM fuel cells.

11. A method for operating a fuel cell system, comprising:
providing a fuel cell stack having a gas inlet side and a gas outlet side where the gas outlet side has a flush cell with an assigned flush arranged;
supplying a reaction gas on the gas inlet side;
measuring a voltage of the flush cell in a region of the flush cell where a concentration of the reaction gas falls most quickly to a predetermined threshold value; and
controlling an actuation of the flush valve as a function of the measured voltage.

12. The method as claimed in claim 11, further comprising a plurality of fuel cell stacks are arranged in a cascade-like manner where the reaction gas passes through the plurality of fuel cell stacks in series.
